(19) United States
(12) Patent Application Publication
(10) Pub. No.: US 2018/0292510 A1
(43) Pub. Date: Oct. 11, 2018

(54) CALIBRATION OF A CASCADED RADAR SYSTEM

(71) Applicant: Texas Instruments Incorporated, Dallas, TX (US)

(72) Inventors: Sandeep Rao, Bangalore (IN); Brian Ginsburg, Dallas, TX (US)

(73) Assignee: Texas Instruments Incorporated, Dallas, TX (US)

(21) Appl. No.: 15/692,010

(22) Filed: Aug. 31, 2017

(30) Foreign Application Priority Data
Apr. 7, 2017 (IN) 201741012567

(51) Int. Cl. G01S 7/40; H01Q 3/26

(52) U.S. Cl. CPC G01S 7/4008; H01Q 3/267; G01S 7/4021

(57) ABSTRACT

A cascaded radar system includes a device that is cascaded to another device to form a virtual antenna array, which may be used by each cascaded device to receive a return-microwave radar signal. A determination of a common dominant signal from the cascaded devices may be used to determine a phase mismatch, which is further utilized as a basis for adjusting a signal phase of the formed virtual antenna of the cascaded radar system.

### RELATED APPLICATIONS

This application claims the benefit of priority of Indian Provisional Patent Application Serial No. 201741012567 filed Apr. 7, 2017, incorporated herein by reference.

### BACKGROUND

Range resolution, Doppler resolution, and angle resolution are key metrics that may characterize performance and efficiency of a radar system. For example, a single radar chip may provide a good range and a good Doppler resolution. However the angle resolution that may be provided by a single radar chip is often limited by the number of transmit (TX) and receive (RX) channels that can be supported by the single chip.

To improve angle resolution, multiple chips may be cascaded so that a greater number of TX and RX channels are available. However, in a cascaded setup, the angle resolution may be affected by various sources. For example there may be variations in group delay of transmitter power amplifiers (TX PA) or receiver low-noise amplifiers (RX LNA) across devices. Another reason may be that the Local Oscillator (LO) distribution (across the devices) may have routing mismatches. Some of these errors may be calibrated in the factory using procedures which involve objects (reflectors) placed at known locations with respect to the radar system. However, such a factory calibration procedure may not take care of temperature and aging variations during the lifetime of the product.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an example scenario illustrating an example application of a cascaded radar system as described herein.

FIG. 2 illustrates an example cascaded radar system as described in present implementations herein.

FIG. 3 illustrates an example implementation of on the fly calibration by a cascaded radar system as described herein.

FIG. 4 shows an example determination of a second phase mismatch from a different frame index and/or different range-Doppler bins as described in present implementations herein.

FIG. 5 illustrates an example multiple inter-device mismatch graph showing a series of inter-device mismatches corresponding to different frame indices and/or different range-Doppler bins as described herein.

FIG. 6 shows an antenna configuration illustrating a different combination of formed virtual antennas as described herein.

FIG. 7 is an example process chart illustrating an example method for on the fly—calibration of a cascaded radar system as described herein.

### SUMMARY

Described herein is a technology for calibrating a cascaded radar system. The cascaded radar system, for example, may include a device that is cascaded to another device to form a virtual antenna array. In this example, the virtual antenna array may include a larger number of combined TX and RX antenna elements.

Using the formed virtual antenna array, an on the fly calibration of the cascaded radar system may include the following steps: first, a microwave radar signal may be transmitted by the device of the cascaded radar system; second, the microwave radar signal may be received and reflected by one or more objects; third, the return microwave radar signal are received and processed by each device of the cascaded devices; fourth, a dominant signal that is common to each device of the cascaded devices may be determined; fifth, a phase mismatch may be determined based on the determined common dominant signal; and sixth, the calibration of the transmitting device may be performed by adjust phase of the virtual antenna based on the determined phase mismatch.

### DETAILED DESCRIPTION

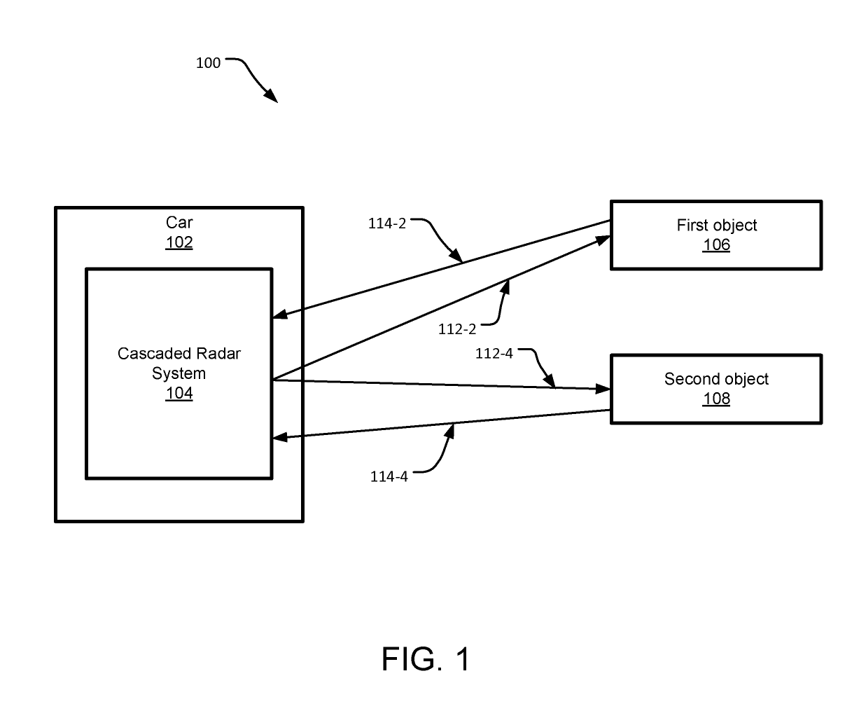

FIG. 1 is an example scenario 100 illustrating an example application of a cascaded radar system as described herein. As shown, the scenario 100 includes a car 102 with a cascaded radar system 104, a first object 106, a second object 108, transmitted microwave radar signals 112, and reflected return-microwave radar signals 114. An on the fly calibration as described herein may be implemented during a normal operation of the cascaded radar system. A normal operation is a mode where the radar system 104 is transmitting and receiving radar signals for the purpose of locating the position and velocity of objects in front of the radar system 104.

The cascaded radar system 104 may include two or more chips or devices that are used to perform the on the fly calibration. For example, each chip (hereinafter referred to as device) may be cascaded to another device. In this example, the cascading of the two or more devices may provide a higher number of virtual antenna arrays to form a multiple input multiple output (MIMO) system and thus improving an angle resolution of the cascaded radar system.

The cascaded radar system 104 transmits, for example, the transmitted microwave radar signals 112-2 to the direction of the first object 106. The transmitted microwave radar signal 112-2 may include multiple frames and in a case of a Frequency Modulated Continuous radar system, for example, the microwave radar signal 112-2 may include a group of chirps that are transmitted sequentially in a unit called a frame. In response to this transmission, the virtual antenna arrays of the cascaded radar system 104 may receive the return-microwave radar signals 114-2 from the first object 106.

Similarly, the cascaded radar system 104 transmits, for example, the transmitted microwave radar signals 112-4 to the direction of the second object 108 and in response to this transmission, the same multiple cascaded receivers of the cascaded radar system 104 may receive the return-microwave radar signals 114-4 from the second object 108.

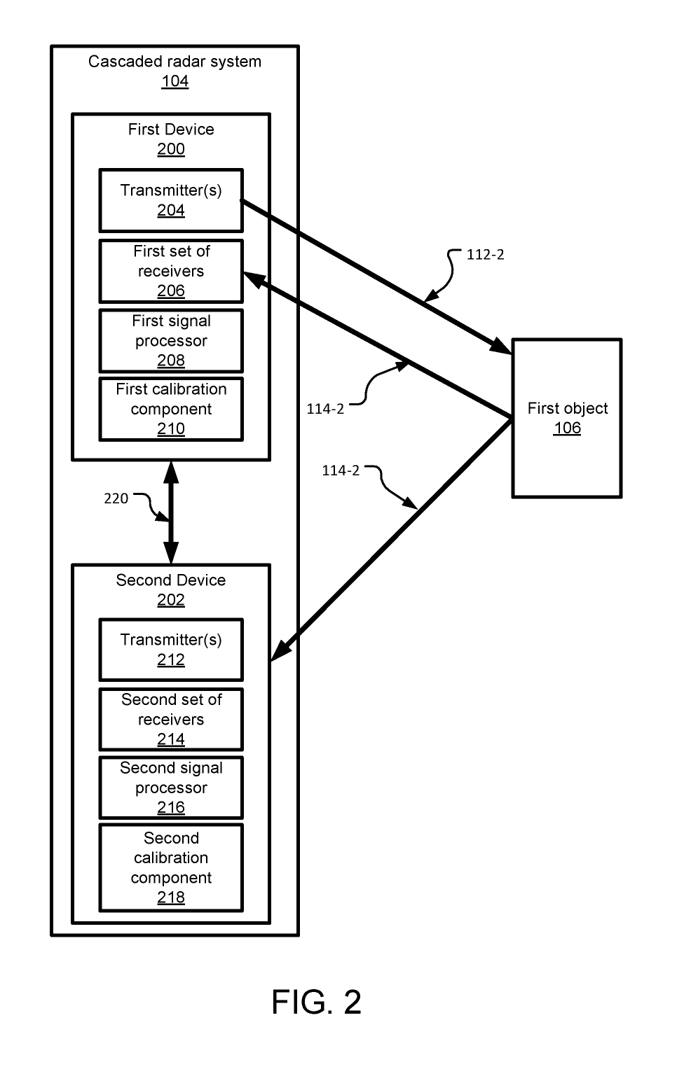

In the examples above, the cascaded radar system 104 may be configured to use the received return-microwave radar signals 114-2 and 114-4 in order to compute phase mismatches as further discussed in FIGS. 2-5 below. With the determined phase mismatches, the cascaded radar system 104 may be configured, during field operations, to apply signal corrections corresponding to the determined phase mismatches from the formed virtual antennas.

Although the example basic block diagram of the radar system 100 illustrates in a limited manner the basic components, other components such as one or more processors, storage, applications, memory, etc. are not described in order to simplify the embodiments described herein

FIG. 2 illustrates an example cascaded radar system 104 as described in present implementations herein.

As shown, the example cascaded radar system 104 may include a first device 200 that may be cascaded to a second device 202. The first device 200 may further include one or more transmitters 204 that may be connected to corresponding transmitter antenna (not shown), a first set of receivers 206 that may be connected to corresponding receiver antenna (not shown), a first signal processor 208, and a first calibration component 210.

Similarly, the second device 204 may further include one or more transmitters 212 that may be connected to another set of transmitter antenna (not shown), a second set of receivers 214 that may be connected to another set of receiver antenna (not shown), a second signal processor 216, and a second calibration component 218. Although the example cascaded radar system 104 illustrates a limited number of devices i.e., two cascaded devices, additional devices may be cascaded to the first and second devices 200 and 202 without affecting the implementations described herein.

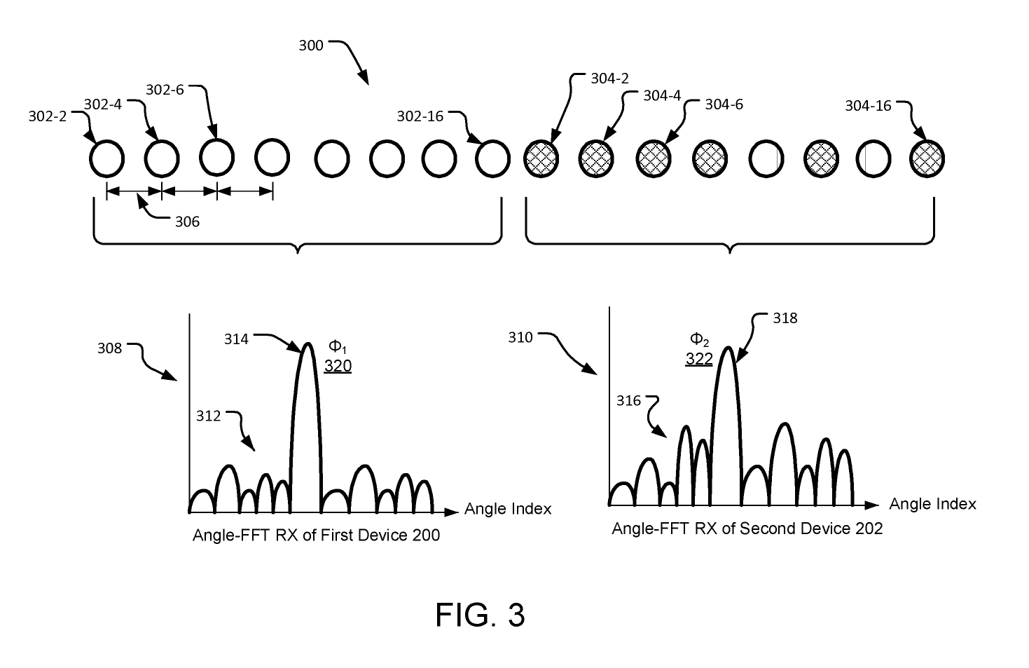

To perform an example calibration, multiple transmitters from the transmitter(s) 204 may transmit the microwave radar signal 112-2, which may include sequential frame transmissions across the transmitting multiple transmitters 204. The first object 106 may receive the transmitted microwave radar signal 112-2, and may reflect back the return-microwave radar signals 114-2 to the cascaded radar system 104. As a consequence, the first set of receivers 206 and the second set of receivers 214 of the first and second devices 200 and 202, respectively, may receive the return-microwave radar signals 114-2. In this example calibration, a determined phase mismatch as further discussed in FIG. 3 below may represent the phase mismatch due to delay-mismatches between the receivers 206 and 214 in response to the transmitted microwave radar signal 112-2 from the transmitters 204 of the first device 200.

As described herein, a virtual antenna array may be formed from the sequential transmission within a frame by the transmitters 204. For example, for two transmitting transmitters 204 and four receiving receivers 206 that are in operation at the first device 200, 8 virtual antennas (i.e., 2×4=8) virtual may be formed. Similarly, for the same two transmitting transmitters 204 from the first device 200, and four receiving receivers 214 at the second device 202, 8 virtual antennas (i.e., 2×4=8) virtual may be formed at the second device 202.

With the received return-microwave radar signals 114-2, the first signal processor 208 may be configured to perform an initial processing of signals for each virtual antenna. For example, the initial processing includes down-conversion of the signal to an Intermediate Frequency (IF) signal; filtering and sampling of the IF signal; and performing a 2 dimensional FFT on the sampled IF signal. The initial processing may further create a range-Doppler matrix for each virtual antenna of the formed virtual antenna array on the first device 200 and each element of the created range-Doppler matrices may be referred to as a range-Doppler bin.

The first signal processor 208 may be further configured to perform a detection step which identifies the range-Doppler bins that correspond to the return-microwave radar signal 114-2 from the reflecting object such as the first object 106. The detection step, for example, includes identifying a range-Doppler bin on each of the virtual antennas on the first device 200. Thereafter, the first signal processor 208 may be configured to perform the FFT algorithm across the range-Doppler bins of the detected objects. In this case, the FFT algorithm provides angle FFT of the reflecting first object 106.

For example, for each signal frame of the received return-microwave radar signals 114-2, the FFT algorithm is performed across the range-Doppler bins (corresponding to the signal 114-2 from the first object 106) of the virtual antennas. In this example, the FFT output (i.e., angle-FFT) may show corresponding signal magnitudes, angle-index, and phase of the received return-microwave radar signals 114-2.

The angle index may particularly refer to the index of a dominant signal in the angle-FFT and directly corresponds to the angle of arrival of an object. The dominant signal, for example, may include the signal with a substantially high magnitude in the angle-FFT. The parameters of this dominant signal (such as the angle-index, magnitude and phase) may be stored to be used as a reference for comparison to the parameters of the signals received by the second device 202 on the same particular frame and at the same range-Doppler bin.

In detecting or determining the dominant signal, the first signal processor 208, for example, may utilize a pre-defined magnitude-threshold. Alternatively, the dominant signal may also be determined by identifying a signal peak with a magnitude that is above a pre-defined threshold relative to the surrounding signals in the angle-FFT. In this example, the dominant signal may include the signal that includes a substantially high magnitude as compared to surrounding signals in the angle-FFT on the same range-Doppler bins of the same index frame. Thereafter, the determined dominant signal (or its parameters) may be stored by the first device 200.

At the second device 202, the second signal processor 216 may be similarly configured to perform the initial processing, the detection step, and perform the FFT algorithm as described above for the first device 200. In this case, the second signal processor 216 may facilitate the determination of the signal magnitude, angle index, and phase of the dominant signal as seen from the second device 102. The parameters of the determined dominant signal are stored and used for comparison to the stored dominant signal on the first device 200. The second signal processor 216, similar to the first signal processor 208, may similarly utilize the same pre-defined magnitude-threshold in determining the dominant signal as seen from the second device 202.

With the stored dominant signals on the first device 200 and the second device 202, the stored dominant signals on the same range-Doppler bins of the same frame are compared. For example, the comparison yields a pair of dominant signals (i.e., one from first device 200 and one from the second device 202) which are found to have the same angle-index in the angle-FFT and of substantially the same magnitude (i.e. magnitudes differ by less than a pre-defined threshold). In this example, the pair may be referred to as a common dominant signal.

For example, the first device 200, which performed the transmission of the microwave radar signals 112-2, may be configured to determine presence of the common dominant signal over a particular frame of the received return-microwave radar signals 114-2. In this example, the first signal processor 208 may compare the dominant signals stored on the first device 200 and the dominant signals stored second device 202 over the same range-Doppler bin within the same frame. In response to the determination of the common dominant signal, the first signal processor 208 may be further configured to estimate phase difference of the determined common dominant signal.

The determined common dominant signal may occur at the same range-Doppler bin within the same frame, and have the same angle-index and substantially similar magnitudes. However, due to variations in group delay between the devices, routing mismatches and the like, the phase values of the common dominant signal as seen from the first device 200 and as seen from the second device 202 may be different. Accordingly, the first signal processor 208 may be configured to determine the phase mismatch between the cascaded first device 200 and the second device 202, and based from the determined phase mismatch, the first signal processor 208 may be configured to perform on the fly calibration or adjustment of the phases of the received signals at the first set of receivers 206 in the first device 200. Alternatively, the second signal processors 216 may adjust phases of the second set of receivers 214 in the second device 202. The adjustment of the phases may be performed to overcome the distortion introduced in the received signal due to device mismatches such as routing mismatches, group delay mismatches etc.

The calibration of the transmitter(s) 204 and 212 may further be based upon multiple common dominant signals stored on the first device 200 and the second device 202. That is, different common dominant signals corresponding to reflections from different objects that are identified in different frames and across different range-Doppler bins may be gathered from the first and second devices. Not every range-Doppler bin will have a common dominant signal. The calibration procedure scans through range-doppler bins across frames to identify range-doppler bins which satisfy the conditions for a common dominant signal. For each identified common dominant signal a corresponding phase mismatch is computed. The gathered phase mismatches may be filtered by excluding the phase mismatches that are identified as outliers as further discussed below. Thereafter, the filtered phase mismatches may be averaged to obtain an average phase mismatch between the virtual antenna arrays of the first and second devices. The obtained average phase mismatch may treated as a single phase mismatch that occur in different frames and different range-Doppler bins.

A data path 220 allows first device 200 and second device 202 to share data. In particular, first signal processor 208 and second signal processor 216 can share information on dominant signals. In other implementations, a single processor or processors reside external to devices 200 and 202, and communicate to devices 200 and 202.

FIG. 3 illustrates an example implementation of on the fly calibration by a cascaded radar system as described herein. As shown, an antenna configuration 300 may be formed from the cascading of the first device 200 and the second device 202. The formed antenna configuration 300 may be a virtual MIMO antenna that includes a combined set of virtual antennas 302 and 304 from the first device 200 and the second device 202, respectively. Furthermore, the antenna configuration 300 may include an inter-element spacing 306 that defines distance in wavelength such as about a half wavelength (X/2) in between antenna elements.

Referencing FIG. 3, the transmission of the radar microwave signal 112-2 by the two transmitters 204 of the first device 200, and received by each four antenna elements of the first device 200 and the second device 202, may generate the antenna configuration 300. Based on the two transmitting transmitters 204, the cascading of the first device 200 and the second device 202 may form the virtual MIMO antenna array of about 16 elements as shown by the set of virtual antennas 302 and 304. In this implementation, a larger number of virtual antenna array or elements due to the cascading of the devices may result in an improved angle resolution of the cascaded radar system 104.

FIG. 3 further illustrates an example first signal graph 308 and an example second signal graph 310 that were derived and stored by the first device 200 and the second device 202, respectively. The first signal graph 308 and the second signal graph 310, for example, may be derived through the set of virtual antennas 302 and 304, respectively. In this example, the first signal graph 308 and the second signal graph 310 are FFT algorithm outputs (i.e., represented as angle-FFT) for a particular range-Doppler bin of the same frame index on the received return-microwave radar signals.

As described above, the on the fly calibration may include the following steps: first, the microwave radar signal such as the microwave radar signal 112 may be transmitted by the first and/or the second device; second, the microwave radar signal may be reflected by one or more objects such as the first object 106; third, the return microwave radar signal are processed by each device of the cascaded devices; fourth, the dominant signal that is common to each device of the cascaded devices may be determined; fifth, the phase mismatch may be determined based on the determined common dominant signal; and sixth, the calibration may be performed on the phase of the received signals at the antennas of each of the two cascaded devices based on the determined phase mismatch.

Based from the foregoing, the first signal graph 308 shows the stored signals on the first device 200 for a particular frame of the received return-microwave radar signal. The first signal graph 308 depicts an angle-FFT 312 which is the FFT performed on the virtual antennas 302-2 through 302-16 corresponding to the first device 200. This further includes a first dominant signal 314 that may be derived by comparing magnitude of each signal peak from the first signal graph 308 to the magnitude-threshold. The magnitude-threshold, for example, may be defined as a relative value based on the signal values surrounding each peak.

Similarly, the second signal graph 310 shows stored signals on the second device 202 for the same particular frame and the same range-Doppler bin of the received return-microwave radar signal. The second signal graph 310 depicts an angle-FFT 316 which is the FFT performed on the virtual antennas corresponding to the second device (namely 304-2 through 304-16). This may further include a second dominant signal 318 that may be derived by comparing the magnitude of each signal peak from the second signal graph 310 to the magnitude-threshold. In some examples the magnitude threshold may be defined as a relative value based on the signal values surrounding the peak.

With the first dominant signal 314 and the second dominant signal 318, the common dominant signal may be determined when the determined first dominant signal 314 and the second dominant signal 318 have the same angle-index and substantially of the same magnitude. Based from the determined common dominant signal, the inter-device phase mismatch may be computed.

For example, the determined first dominant signal 314 and second dominant signal 318, which constitute the common dominant signal, have a first signal phase (Φ₁) 320 and a second signal phase (Φ₂) 322, respectively. In this example, the difference between the second signal phase 322 and the first signal phase 320 may be computed and used as basis for determining a first inter-device phase mismatch. Particularly, the first inter-device mismatch (Φ_{mismatch1}) may be computed using formula (1) below:

Φmismatch1=Φ2−Φ1−22/2222 22 (1)

where N_{fft} is the size of angle-FFT of the first device 200 and the second device 202; “2” is the angle-index on the angle-FFT of the common dominant signal; and “2” is the distance (in units of λ/2) from the first virtual RX antenna corresponding to first device 200 (i.e., virtual antenna 302-2) and the first virtual RX antenna corresponding to the second device 202 (i.e., virtual antenna 304-2).

In the example calibration implementation above, the first inter-device mismatch (Φ_{mismatch1}) may represent the phase mismatch due to delay-mismatches between the receivers 206 and 214 in response to the transmitted microwave radar signal 112-2 from the transmitters 204 of the first device 200.

In another example calibration configuration where the signal transmission from the transmitters 212 of the second device 200 are utilized, and the receivers 206 and 214 process the return microwave signals to determine the common dominant signal, the determined phase mismatch in this case may represent the phase mismatch due to delay mismatches between the receivers 206 and 214 in response to the transmission of microwave radar signals from the second device 202.

Still in another example calibration configuration where the signal transmission is transmitted from both transmitters 204 and 212 while the receiver 202 processes the return microwave signals to determine the common dominant signal, the determined phase mismatch may represent the phase mismatch due to delay mismatches between the transmitters 204 and 212 as seen at the first receiver 206.

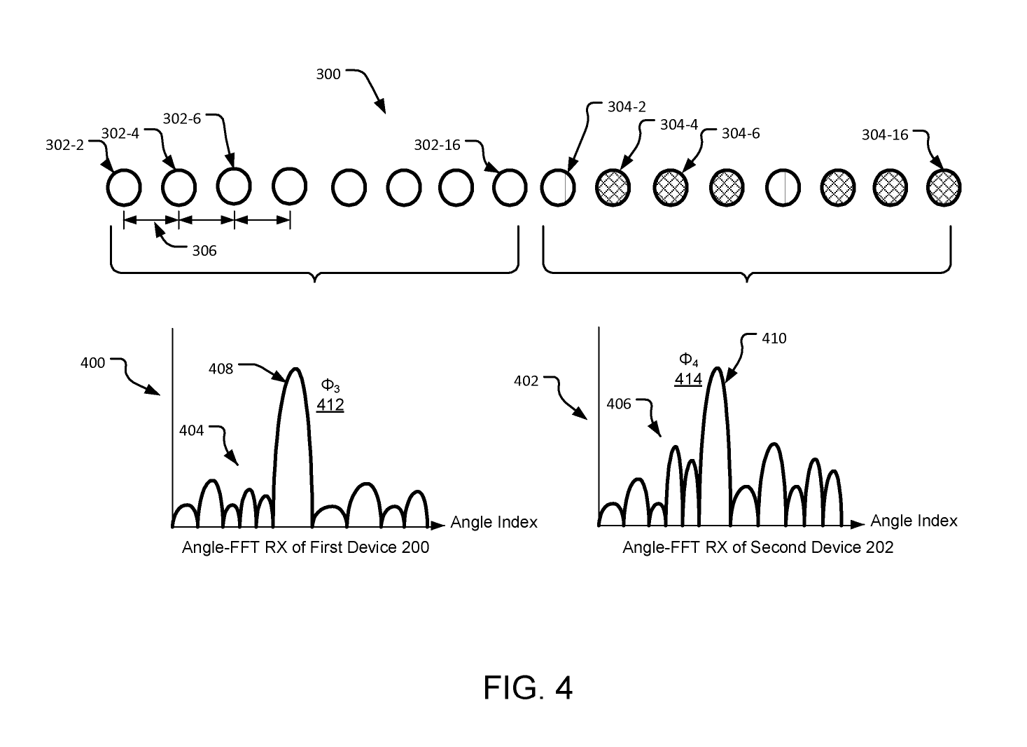

FIG. 4 shows another example determination of a second phase mismatch from another different frame index and different range-Doppler bins of the received-return microwave radar signals as described in present implementations herein. The second phase mismatch from the different frame index and/or different range-Doppler bins may involve another object that reflected the return-microwave radar signal.

As described herein, the receiving of the return-microwave radar signals through the antenna configuration 300 may yield multiple range-Doppler bins with different dominant signals. Following the process described in FIG. 3 above, a first signal graph 400 from the first device 200 and a second signal graph 402 from the second device 202, may include signals 404 and 406, respectively, from a different range-Doppler bins and different frame index as compared to FIG. 3 above.

The signals 404 may further include, for example, a third dominant signal 408 that is above the magnitude-threshold, while the signal 406 further shows a fourth dominant signal 410. The signals 404 and 406 may illustrate the FFT algorithm outputs (i.e., angle-FFT) for the range-Doppler bin and/or frame index that is different from the range-Doppler bin and/or frame index as described in FIG. 3 above.

Referencing the first signal graph 400 and the second signal graph 402, the first signal processor 208 of the first device 200, for example, may determine the common dominant signal. In this example, the common dominant signal may be represented by the third dominant signal 408 and the fourth dominant signal 410, which may be found on the same angle index on each of the two cascaded devices. In this example, the determination of a second inter-device mismatch (Φ_{mismatch2}) may be based on the determined common dominant signal.

For example, the determined third dominant signal 408 and the fourth dominant signal 410 has a third signal phase (Φ₃) 412 and a fourth signal phase (Φ₄) 414, respectively. In this example, the difference between the third signal phase (Φ₃) 412 and fourth signal phase (Φ₄) 414 may be computed and used as basis for estimating a next inter-device phase mismatch. Particularly, the second inter-device mismatch (Φ_{mismatch2}) may be computed using formula (2) below:

Φmismatch2=Φ4−Φ3−22/2222 2′2 (2)

where N_{fft} is the size of the the angle-FFT of the first device 200 and the second device 202; k′ is the angle-index (i.e., index in the angle-FFT) of the common dominant signal; and “d” is the distance (in units of λ/2) from the first virtual RX antenna corresponding to first device 200 (i.e., virtual antenna 302-2) and the first virtual RX antenna corresponding to the second device 202 (i.e., virtual antenna 304-2).

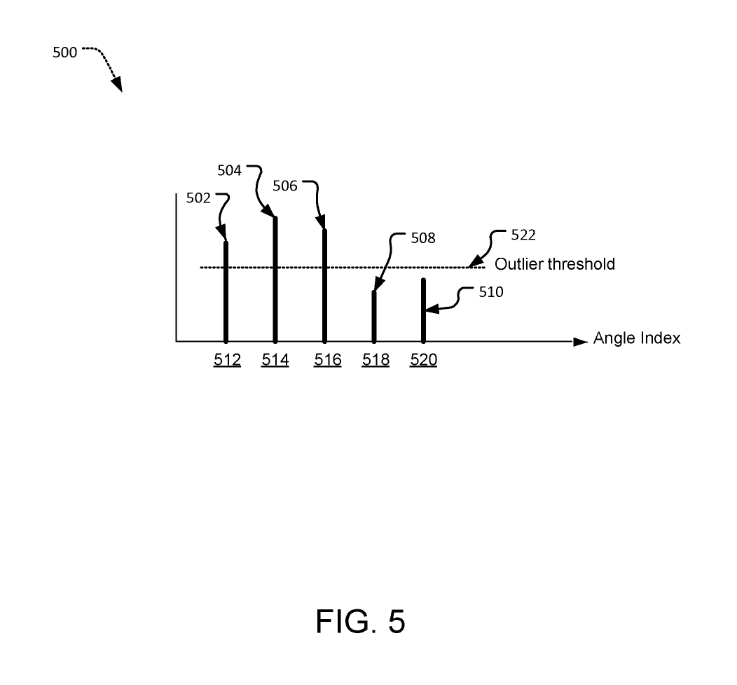

FIG. 5 illustrates an example multiple inter-device mismatch graph 500 showing a series of different inter-device mismatches corresponding to different frame indices and/or different range-Doppler bins as described herein. Particularly, FIG. 5 shows a first inter-device mismatch (Φ_{mismatch1}) 502, a second inter-device mismatch (Φ_{mismatch2}) 504, a third inter-device mismatch (Φ_{mismatch3}) 506, a fourth inter-device mismatch (Φ_{mismatch4}) 508, and a fifth inter-device mismatch (Φ_{mismatch5}) 510. In this example, the different inter-device mismatches 502-510 may correspond to different range-Doppler bins 512-520, respectively. The different range-Doppler bins, for example, may be spread out across different multiple frames.

Prior to determining of the average mismatch of the different inter-device mismatches 502-510, an outlier detection and removal process (i.e., filtering) may be first implemented. For example, each inter-device mismatch may be compared to an outlier-threshold 522. In this example, and referencing the different inter-device mismatches 502-510, the fourth inter-device mismatch (Φ_{mismatch4}) 508 and the fifth inter-device mismatch (Φ_{mismatch5}) 510 are below the outlier-threshold 522. In this case, the first inter-device mismatch (Φ_{mismatch1}) 502, second inter-device mismatch (Φ_{mismatch2}) 504, and the third inter-device mismatch (Φ_{mismatch3}) 506, which are within the outlier-threshold 522, may be averaged to generate the average mismatch (Φa_{vegmismatch}) as shown by formula (3) below:

Φavegmismatch=2 2 222 222222 2 222 2222222 2 222 22222/2 (3)

In another implementation, the inter-device mismatches that are below the outlier-threshold 522 may also be identified by computing the mean and variance of the inter-device phase mismatches 502-510. For example, the inter-device phase mismatch(es) that are furthest away from the mean are excluded. In this example, the variance is re-computed and in a case where the original variance is larger than the re-computed variance by more than a pre-defined ratio, the excluded inter-device phase mismatch value is considered as an outlier (i.e., similar to below the outlier-threshold 522). In this other implementation, the process may be repeated iteratively to sequentially remove multiple outliers. Other techniques of outlier detection such as those based on clustering may also be used.

As an alternate to the use of the FFT algorithm above, an Eigen-value based algorithm may be used to determine the presence of a common dominant signal. For example, for a single object present in the range-Doppler bin, the Eigen-values of a 2×2 correlation matrix corresponding to the virtual antenna array of the antenna configuration 300 may have a single dominant Eigen-value. The Eigen algorithm may proceed as follows:
for a set Q of 2×1 and all vectors rₖ=[sₖ, sₖ₊₁] consisting of signals (from a specific range-Doppler bin of a specific frame and all adjacent pairs of virtual antenna elements that correspond to the same device) i.e., [virtual antenna 302-2, virtual antenna 302-4], [virtual antenna 302-4, virtual antenna 302-6], etc. with exception of [virtual antenna 302-16, virtual antenna 304-2], the 2×2 correlation matrix 2=Σ₂2₂²2₂ (where T refers to the transpose of the matrix) is determined;
after determining the 2×2 correlation matrix R, the 2 Eigen values of R are computed;
thereafter, a ratio of the two Eigenvalues (ratio of the smaller eigenvalue to the larger Eigen value) may be computed. This ratio is used to determine whether or not the range-Doppler bin contains a common dominant signal. For example this ratio is compared against an SNR dependent threshold, and the presence of a common dominant signal is declared if the ratio is less than this SNR dependent threshold.
Once the presence of a common dominant signal has been identified using the above procedure, the phase of the common dominant signal corresponding to each of the devices can be found using know techniques such as FFT's or Multiple Signal classification (MUSIC)

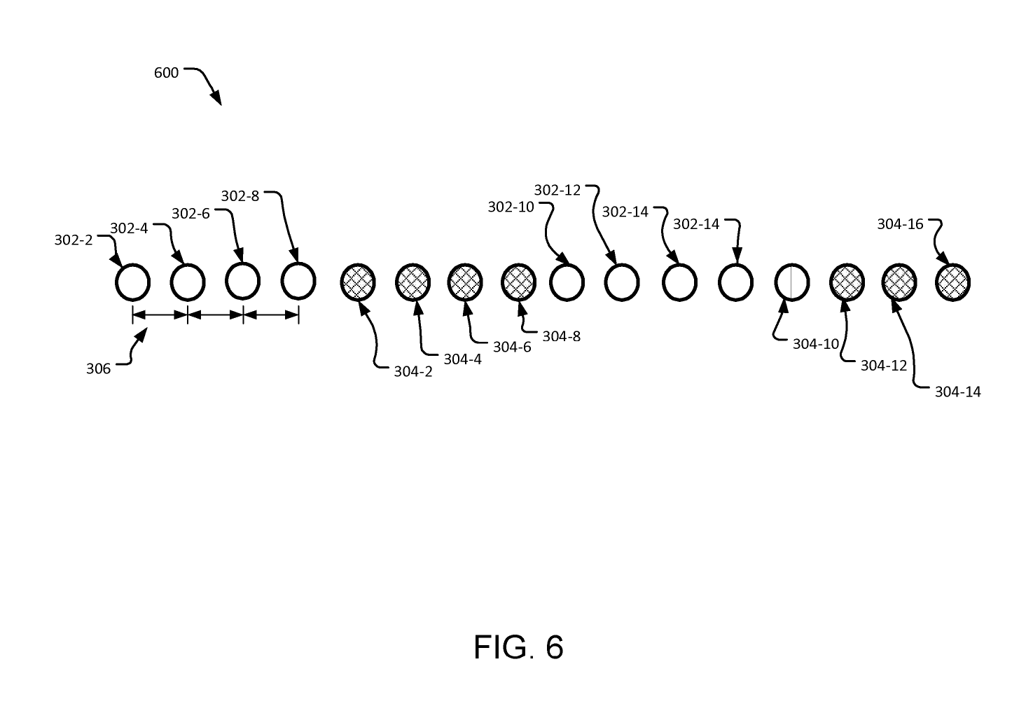

FIG. 6 shows an antenna configuration 600 illustrating a different combination of the set of virtual antennas 302 and 304 from the first device 200 and the second device 202, respectively. In FIGS. 3-4 above, each element of the set of virtual antennas 302 and 304 were contiguously located. However, as shown in FIG. 6, the virtual antennas 304-2 to 304-8 of the second device 202 may be contiguously located after the virtual antennas 302-2 to 302-8 of the first device 200. For example, there is a gap of 4 antenna elements in between the virtual antennas 302-2 to 302-8 and the virtual antennas 302-10 to 302-14 of the first device 200. In this example, the gap may be utilized by the FFT algorithm for analyzing the return-microwave radar signals. That is, the FFT algorithm, for example, may incorporate the gap by appropriate zero padding or zero insertion.

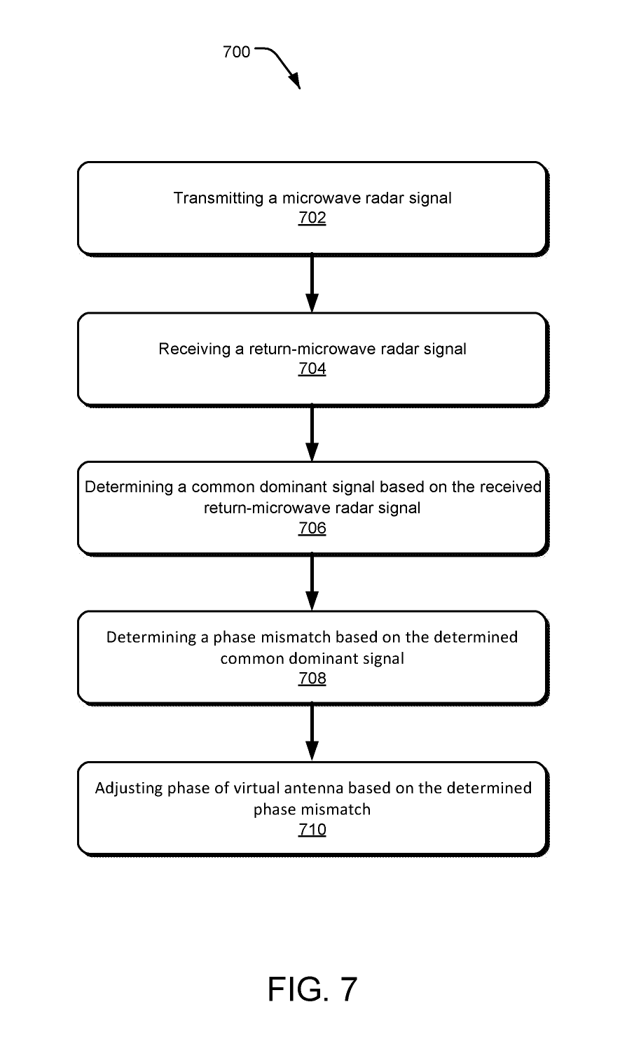

FIG. 7 shows an example process chart 700 illustrating an example method for on the fly—calibration of a cascaded radar system as described herein. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 702, transmitting a microwave radar signal by a first device that is cascaded to a second device is performed. For example, the cascaded radar system 104 includes the first device 200 that may be cascaded to the second device 202. In this example, the transmitter 204 of the first device 200 may transmit the microwave radar signal that may be used for calibrating the first device 200 and/or the second device 202. The cascading of the first device 200 and the second device 202 may form larger virtual antenna array such as the virtual antenna configuration 300.

At block 704, receiving of a return-microwave radar signal is performed. For example, the first device 200 and the second device 202 may receive the return-microwave radar signal from the first object 106 and through the virtual antenna configuration 300. In this example, the each of the first device 200 and the second device 202 may detect and store a dominant signal based on the received return-microwave radar signal. In this example still, each of the first and second devices may utilize the FFT algorithm to determine the dominant signal such as the first dominant signal 314, second dominant signal 318, etc. The dominant signal may include the signal with a substantially higher magnitude as compared to other signals within the angle-FFT of the same range-Doppler bin.

At block 706, determining a common dominant signal from the cascaded first and second devices is performed. For example, the first signal processor 208 or the second signal processor 216 of the first device 200 and the second device 202, respectively, may be configured to determine the common dominant signal between the first and second devices. The common dominant signal may include the dominant signals on a particular range-Doppler bin for a particular frame and of the same angle-index in the angle-FFT. The process moves to 708 only if a common dominant signal is identified in block 706.

At block 708, determining a phase mismatch between the cascaded devices based on the determined common dominant signal is performed. For example, the first signal processor 208 or the second signal processor 216 of the first device 200 and the second device 202, respectively, may be configured to determine the phase mismatch by using formula (1) above to obtain value of the phase mismatch such as the inter-device mismatch (Φ_{mismatch1}).

At block 710, adjusting virtual antenna signal phases of the first device or the second device based on the determined phase mismatch is performed. For example, the first calibration component 210 of the first device 200 may be configured to adjust a phase of the signal received at the first set of receivers 206 of the first device 200 based on the determined phase mismatch between the cascaded devices. In this example, the phase adjustment of the receive signal may include adjustment of the virtual antennas of the first device 200.

In the foregoing blocks 702-710, the steps on the blocks 702-704 may occur during a normal operation of the radar system. However, for blocks 706-710, these may be additional computations that may be performed during normal operation in order to opportunistically determine the common dominant signals across the virtual antennas of the multiple devices. The common dominant signals, as discussed above, may be utilized to determine and correct inter-device phase mismatches.

What is claimed is:

1. A radar system comprising:
a first device configured to transmit a microwave radar signal;
a second device cascaded to the first device to form a virtual antenna array that receives a return-microwave radar signal from an object, wherein each device detects and stores a dominant signal based on the received return-microwave radar signal;
a processor configured to determine a phase mismatch based on a common dominant signal between the first and second devices, the common dominant signal includes a signal with a magnitude higher than the other return signals received from the object and located within the same range-Doppler bin of the received return-microwave radar signal;
a calibration component configured to adjust a signal phase of the virtual antenna array based on the determined phase mismatch.

2. The radar system of claim 1, wherein the formed virtual antenna array includes a combined transmitter and receivers of the first and second devices.

3. The radar system of claim 1, wherein the substantially high magnitude of the dominant signal includes a magnitude that is above a pre-defined magnitude-threshold.

4. The radar system of claim 1, wherein an inter-element spacing of the formed virtual antenna array is half wavelength (λ/2).

5. The radar system of claim 1, wherein each of the first and second devices performs a Fast Fourier Transform (FFT) algorithm on the received return-microwave radar signals to identify the presence of and generate the dominant signal as seen from each of the first and second devices.

6. The radar system of claim 1, wherein the processor is further configured to determine a series of phase mismatches based on multiple common dominant signals detected across multiple range-Doppler bins and across multiple frames.

7. The radar system of claim 6, wherein the signal processor is configured to perform one or more of the following:
identifying and excluding outliers from the determined series of phase mismatches to produce a filtered set of phase mismatches;
averaging the filtered set of phase mismatches to obtain an averaged phase mismatch, wherein the signal phase of the virtual antenna array is adjusted based on the averaged phase mismatch.

8. The radar system of claim 1, wherein the signal processor is configured to use Eigen-value algorithm in determining the common dominant signal on the range-Doppler bin.

9. A method of calibrating a radar system comprising:
transmitting of microwave radar signals by a first device that is cascaded to a second device to form a virtual antenna array;
receiving of return-microwave radar signals through the formed virtual antenna array, the receiving includes a detection and storage of a dominant signal by each of the first and second devices;
determining a common dominant signal between the first and second devices, the common dominant signal includes a signal with a magnitude higher than the other return signals received from the object and located within the same angle index of the received return-microwave radar signal;
determining a phase mismatch between the cascaded devices based on the determined common dominant signal;
adjusting a phase of the virtual antenna array based on the determined phase mismatch.

10. The method of radar calibration of claim 9, wherein the first and second devices utilize Fast Fourier Transform (FFT) algorithm on the received return-microwave radar signal to detect the dominant signal.

11. The method of radar calibration of claim 9, wherein the determining of the mismatch further includes: comparing a phase of the common dominant signal as seen from the first device and as seen from the second device.

12. The method of radar calibration of claim 9, wherein the determining of the mismatches further comprises:
comparing the phase mismatch to a range-threshold;
filtering the phase mismatch that is outside of the range-threshold;
averaging the phase mismatches that are within the range-threshold.

13. The method of radar calibration of claim 9, wherein the determining the common dominant signal includes the use of Eigen-value algorithm.

14. The method of claim 9, wherein the virtual antenna array includes a first and second sets of receivers.

15. A cascaded radar system comprising:
a first device configured to transmit a microwave radar signal;
a second device cascaded to the first device to form a virtual antenna array that receives return-microwave radar signals from an object, wherein each device detects and stores a dominant signal based on the received return-microwave radar signal;
a processor configured to determine a common dominant signal between the first and second devices, the common dominant signal is used by the processor to determine a phase mismatch;
a calibration component configured to adjust a phase of the virtual antenna array based on the determined phase mismatch.

16. The cascaded radar system of claim 15, wherein the formed virtual antenna array includes a combined transmitter and receivers of the first and second devices.

17. The cascaded radar system of claim 15, wherein the common dominant signal includes a signal with a substantially high magnitude and located within the same range-Doppler bin of the received return-microwave radar signal.

18. The cascaded radar system of claim 15, wherein an inter-element spacing of the formed virtual antenna array is half wavelength (λ/2).

19. The cascaded radar system of claim 15, wherein each of the first and second devices performs a Fast Fourier Transform (FFT) algorithm on the received return-microwave radar signals to generate the dominant signal as seen from each of the first and second devices.

20. The cascaded radar system of claim 15, wherein the processor is further configured to determine a series of phase mismatches based on multiple common dominant signals detected across multiple range-Doppler bins and across multiple frames.
